(19) United States
(12) Patent Application Publication
(10) Pub. No.: US 2007/0017228 A1
(43) Pub. Date: Jan. 25, 2007

(54) Method for enhancing the efficient operation of electrical power plants and energy storage

(75) Inventor: Jeffrey E. Surma, Richland, WA (US)

Correspondence Address: Douglas E. McKinley, Jr., P.O. Box 202, Richland, WA, 99352, US

(73) Assignee: Integrated Environmental Technologies, LLC

(21) Appl. No.: 11/177,152

(22) Filed: Jul. 6, 2005

(51) Int. Cl. A62D 3/00; A62D 3/19

(52) U.S. Cl. 60/780; 588/311

(57) ABSTRACT

A method for enhancing the efficient operation of an electrical power plant utilizing a waste conversion unit to convert organic matter and electrical power into a useful fuel. The waste conversion unit is in electrical communication with an electrical power plant, where it uses electrical power from the electrical power plant and organic matter to form a useful fuel during periods when the electrical power plant has relatively high excess capacity. The useful fuel is then supplied to an electrical generator during periods of relatively low excess capacity, thereby allowing electrical generator to increase the power delivered by said power plant during periods of peak electricity demand.

### TECHNICAL FIELD

This invention relates to methods for improving the operation of electrical power plants. More specifically, this invention relates to methods for the conversion of electricity produced during off peak hours into energy stored in a chemical form which may then be used to produce additional electricity during peak hours.

### BACKGROUND OF THE INVENTION

Demand for electrical power generated by large scale electrical power plants and delivered to residential and business consumers is known to fluctuate on a regular basis. In the summer months, when the weather is hot, demand is highest during the day, as users operate air conditioning units. In the evening, the demand is lower, as there is less need for air conditioning units. Time periods when demand for electricity is high are referred to by those in the industry as “peak” periods or periods of “peak demand” and, conversely, time periods when demand for electricity is low are referred to by those in the industry as “off-peak” periods or periods of “off-peak” demand.

While large-scale modern electrical power plants can generate tremendous amounts of electrical energy, it is often the case that they only operate at optimum efficiency only when operated at or near the level of electrical energy output for which their design was optimized. While these plants are capable of producing more or less energy than the optimal amount, it is often the case that they do so at a significant penalty in operating efficiency, and thus a much higher cost per Watt. Additionally, operating a power plant in a mode that varies throughout the day (ie. load following) can have detrimental effects on the useful life of the plant and/or require significant increases in the maintenance required to continue to operate the plant. All of these losses of efficiency are particularly pronounced in nuclear, coal fired, and natural gas fired, power plants.

Because electrical use by consumers fluctuates between times of peak and off-peak demand, and power plants operate most efficiently at a constant production rates, there is an inherent mismatch between optimized power production and demand. Other types of power plants can also experience these types of imbalances. For example, electrical power plants such as those in Washington State that use hydropower as the production source typically have relatively high excess capacity in the spring, when runoff from mountain snowpack is at its highest. As used herein, “relatively high excess capacity” simply means that during these time periods, the ratio of demand for electrical energy from a power plant and the capacity of that power plant to produce electrical energy is lower than at other times. Similarly, these same hydropower plants have relatively low excess capacity in the late summer, when runoff from the mountain snowpack is at its lowest. As used herein, “relatively low excess capacity” simply means that during these time periods, the ratio of demand for electrical energy from a power plant and the capacity of that power plant to produce that energy is greater than at other times.

Whether caused by a mismatch between optimized power production and demand, or by seasonal forces such as varying stream flows, there exists a need for methods that enhance the efficiency of power plants by allowing the power plants to operate at optimal efficiency during times of both relatively high excess capacity and relatively low excess capacity, and/or during times of peak demand and times of off-peak demand.

### SUMMARY OF THE INVENTION

Accordingly, one object of the present invention is to provide a method for the improving the efficiency of power plants by allowing the power plants to operate at optimal levels of efficiency during times of both relatively high excess capacity and relatively low excess capacity. Another object of the present invention is to provide a method of storing excess electrical energy produced during times of relatively high excess capacity in a useful form. Another object of the present invention is to allow energy stored during times of relatively high excess capacity to be utilized for supplemental electrical production during times of relatively low excess capacity.

These and other objects are accomplished by the present invention, which is a method for enhancing the efficient operation of an electrical power plant. The present invention accomplishes these and other objectives by first providing a waste conversion unit capable of converting organic matter and electrical power into a useful fuel. In this manner, excess electrical energy produced during times of relatively high excess capacity is converted into chemical energy, where it can be stored and then converted back into electrical energy during times of relatively low excess capacity.

Preferably, but not meant to be limiting, the waste conversion unit is selected as one which utilizes electrical energy to create a plasma. As is known by those having skill in the art, plasma sources such as plasma torches and plasmas formed by applying an electrical potential across a gap between electrodes will rapidly pyrolyze and/or gasify organic materials. In the presence of oxygen, the carbon atoms of the pyrolyzed/gasified organic materials can then be reacted with oxygen either also present in the organic materials and/or provided to the reaction chamber, for example in the form of air, oxygen gas, and/or steam. Within the high temperatures of the reaction chamber, the pyrolyzed carbon atoms and, for example, oxygen from steam, then react to form a useful fuel, for example, a hydrogen rich synthesis gas. Accordingly, as used herein, “useful fuel” means a chemical produced in a waste conversion unit that uses electrical energy to process organic materials into the chemical. The useful fuels of the present invention are readily stored in conventional tanks or vessels commonly used to store fuels.

By providing said waste conversion unit in electrical communication with an electrical power plant, the present invention makes use of electrical energy produced by the electrical power plant during periods in which the electrical power plant has relatively high excess capacity. Not surprisingly, it is during these time periods of relatively high excess capacity that the market price for electrical energy tends to be relatively low. Electrical energy produced by the electrical power plant during this time is converted to a chemical form; for example, and not meant to be limiting, to a useful fuel such as synthesis gas. The useful fuel may then be stored in a liquid or gas form by conventional means, such as tanks, for later use. In this manner, the low cost electricity produced during periods in which the electrical power plant has relatively high excess capacity is combined with organic matter, thereby capturing and storing the energy in a form that allows it to be used during periods when the electrical power plant has relatively low excess capacity, and consequently a much higher price. Energy used to compress and store the useful fuel is also effectively transferred from periods of high excess capacity to periods of low excess capacity. In this manner, in addition to increasing the efficiency of the electrical power plant, the present invention effectively increase the power plants capacity by using the excess power at non-peak power demand cycles. Further, the present invention stabilizes power plant operation and decrease maintenance on power plant by avoiding power output cycling to meet varying grid demands.

By providing the useful fuel formed during periods of relatively high excess capacity to an electrical generator connected to the electrical power plant, and operating the electrical generator during periods of time where the electrical power plant has relatively low excess capacity using the energy stored in chemical form in the useful fuel, the electrical generator increases the power delivered by the electrical power plant during periods of peak electricity demand. Thus, the present invention provides an elegant method for converting low value electricity into high value electricity by converting and storing the energy in chemical form. In this manner, effectively create a super battery for large power production facilities.

In addition, the present invention also provides a disposal pathway for virtually any organic waste product, including but not limited to municipal solid waste, used tires, agricultural waste, and combinations thereof. Configured in this manner, the present invention converts waste into low cost energy. However, the present invention can also make use of materials that have high organic content, but which are not necessarily thought of as waste products. For example, the present invention provides an excellent pathway for capturing the energy value trapped in materials such as tar sands, coal and oil shale.

While not meant to be limiting, it is preferred that the waste conversion unit further utilize electrical power to provide joule heating to a glass bath, in addition to the plasma. The use of joule heating allows the reaction chamber of the waste conversion unit to efficiently remain in a “standby” state during periods when organic materials are not being processed. Further, the use of joule heating avoids thermal cycling between periods of active processing, thereby extending the useful life of the materials, such as the refractory, used to fabricate the waste conversion unit. These waste conversion units have 100% turndown ratio capability, meaning they can be rapidly started from standby to allow operation immediately following periods of relatively high excess capacity, thus capturing excess electricity produced by a power plant immediately following excess power cycles.

The electrical generator used to produce electrical energy during periods of relatively low excess capacity can be any system suitable for converting chemical energy into electrical energy. Accordingly, reciprocating engines, gas turbines, fuel cells, and combinations thereof, are all suitable alternatives for producing electrical energy with the useful fuel in accordance with the present invention.

The invention claimed is:

1) A method for enhancing the efficient operation of an electrical power plant comprising the steps of:
a. providing a waste conversion unit capable of converting organic matter and electrical power into a useful fuel,
b. providing said waste conversion unit in electrical communication with an electrical power plant,
c. providing electrical power from said electrical power plant and organic matter to said waste conversion unit, thereby converting said organic materials and said electrical power into a useful fuel during periods when the electrical power plant has relatively high excess capacity,
d. providing said useful fuel to an electrical generator and operating said electrical generator during periods of time where the electrical power plant has relatively low excess capacity, thereby allowing said electrical generator to increase the power delivered by said power plant during periods of peak electricity demand.

2) The method of claim 1 wherein said electrical generator is selected from the group consisting of a reciprocating engine, a gas turbine, a fuel cell, and combinations thereof.

3) The method of claim 1 wherein said organic matter is selected from the group consisting of municipal solid waste, used tires, tar sands, agricultural waste, and combinations thereof.

4) The method of claim 1 wherein said waste conversion unit utilizes electrical energy to create a plasma.

5) The method of claim 4 wherein said waste conversion unit further utilizes electrical power to provide joule heating to a glass bath.

6) The method of claim 1 wherein said electrical power plant is selected from the group comprising a coal fired plant, a natural gas fired plant, a nuclear plant, and a hydroelectric plant.

7) A method for enhancing the efficient operation of an electrical power plant comprising the steps of:
a. providing a waste conversion unit which utilizes electrical energy to create a plasma and which is capable of converting organic matter and electrical power into a useful fuel,
b. providing said waste conversion unit in electrical communication with an electrical power plant,
c. providing electrical power from said electrical power plant and organic matter to said waste conversion unit, thereby converting said organic materials and said electrical power into a useful fuel during periods when the electrical power plant has relatively high excess capacity,
d. providing said useful fuel to an electrical generator and operating said electrical generator during periods of time where the electrical power plant has relatively low excess capacity, thereby allowing said electrical generator to increase the power delivered by said power plant during periods of peak electricity demand.

8) The method of claim 7 wherein said electrical generator is selected from the group consisting of a reciprocating engine, a gas turbine, a fuel cell, and combinations thereof.

9) The method of claim 7 wherein said organic matter is selected from the group consisting of municipal solid waste, used tires, tar sands, agricultural waste, and combinations thereof.

10) The method of claim 7 wherein said waste conversion unit further utilizes electrical power to provide joule heating to a glass bath.

11) The method of claim 7 wherein said electrical power plant is selected from the group comprising a coal fired plant, a natural gas fired plant, a nuclear plant, and a hydroelectric plant.

12) A method for enhancing the efficient operation of an electrical power plant comprising the steps of:
a. providing a waste conversion unit which utilizes electrical energy to create a plasma in combination with joule heating of a glass bath and which is capable of converting organic matter and electrical power into a useful fuel,
b. providing said waste conversion unit in electrical communication with an electrical power plant,
c. providing electrical power from said electrical power plant and organic matter to said waste conversion unit, thereby converting said organic materials and said electrical power into a useful fuel during periods when the electrical power plant has relatively high excess capacity,
d. providing said useful fuel to an electrical generator and operating said electrical generator during periods of time where the electrical power plant has relatively low excess capacity, thereby allowing said electrical generator to increase the power delivered by said power plant during periods of peak electricity demand.

13) The method of claim 12 wherein said electrical generator is selected from the group consisting of a reciprocating engine, a gas turbine, a fuel cell, and combinations thereof.

14) The method of claim 12 wherein said organic matter is selected from the group consisting of municipal solid waste, used tires, tar sands, agricultural waste, and combinations thereof.

15) The method of claim 12 wherein said electrical power plant is selected from the group comprising a coal fired plant, a natural gas fired plant, a nuclear plant, and a hydroelectric plant.
